(19) United States
(12) Patent Application Publication
(10) Pub. No.: US 2023/0060968 A1
(43) Pub. Date: Mar. 2, 2023

(54) MOLDING CONDITION DISPLAY SYSTEM, MANAGEMENT DEVICE, INJECTION MOLDING DEVICE, AND STORAGE MEDIUM FOR MOLDING CONDITION DISPLAY PROGRAM

(71) Applicant: FANUC CORPORATION, Minamitsuru-gun, Yamanashi (JP)

(72) Inventor: Tatsuhiro UCHIYAMA, Yamanashi (JP)

(21) Appl. No.: 17/793,203

(22) PCT Filed: Jan. 27, 2021
(86) PCT No.: PCT/JP2021/002812

§ 371 Date: Jul. 15, 2022

(30) Foreign Application Priority Data
Feb. 3, 2020 (JP) 2020-016071

(51) Int. Cl. B29C 45/76; B29C 45/17

(52) U.S. Cl. CPC B29C 45/762; B29C 45/1774; B29C 2045/7606

(57) ABSTRACT

The present invention displays the same molding condition on an injection molding device and on an upper level management device. This molding condition display system includes an injection molding device and a management device. The injection molding device comprises: a display; a storage unit for storing a first molding condition display program that causes the display to display molding conditions, and a second molding condition display program that corresponds to the first molding condition display program and that causes a display device of the management device to display the molding conditions stored in the management device; and a transmission unit that transmits the second molding condition display program from the storage unit of the injection molding device to the management device. The management device comprises a reception unit that acquires the second molding condition display program from the injection molding device.

### TECHNICAL FIELD

The present invention relates to a molding condition display system and a molding condition display program storage medium.

### BACKGROUND ART

When a worker at a molding plant performs injection molding injection molding devices, the worker sometimes performs the process of checking the contents of set molding conditions on display devices of each injection molding device and a higher-level management device that manages the plurality of injection molding devices. Specifically, in some cases, the management device stores, in a unified manner, the backup of the molding conditions regarding injection molding by each injection molding device placed at the plant in association with each injection molding device, and a manager checks these injection conditions corresponding to each injection molding device, for example. In this case, e.g., the injection molding device, the molding conditions regarding injection molding are read from a storage unit of the injection molding device, and are displayed on the a play device of the injection molding device y a molding device molding condition display program stored in advance in the storage unit of the injection molding device. On the other hand, in the higher-level management device, the molding conditions regarding injection molding are read from a storage unit of the management device, and are displayed on the display device of the management device by a molding device molding condition display program stored in advance in the storage unit of the management device (see, e.g., Patent Document 1).

In a case where the worker at the molding plant displays the molding conditions by the injection molding device as described above, the molding conditions are generally displayed on the display device of the injection molding device in such a manner that the molding condition display program stored in advance in the storage unit of the injection molding device is read and executed. Similarly, in a case where the manager at the mold in plant displays the molding conditions by the higher-level management device that manages the in molding devices, the molding conditions are generally displayed on the display device of the management device in such a manner that the molding condition display program stored in advance in the storage unit of the management device is read and executed. In this case, when the worker or the manager at the molding plant performs the process of setting the molding conditions or checking the contents of the set mold in conditions on the display of the injection molding device or the display device of the higher-level management device, the form of the molding conditions to be displayed on the injection molding device and the form of the mold in conditions to be c splayed on the higher-level management device are preferably the same as each other.

However, in a case where the injection molding device molding condition display program is changed due to, e.g., function addition or a change in the model of the injection molding device, the mold in condition display program in the higher-level management device that manages the injection molding devices is not always simultaneously changed. For this reason, a case where the form of the molding conditions to be displayed is different between the injection molding device and the higher-level management device is caused, and such inconsistency in the display form leads to a failure to check the contents of the set molding conditions or erroneous setting of the molding conditions. An injection/metering setting screen will be described as one example. FIG. 11A shows a display screen example when molding conditions are displayed by a version-A molding condition display program. On the other hand, FIG. 11B shows a display screen example when the same molding conditions are displayed by a version-B molding condition display program after setting items to be displayed have been added due to version update. Referring to FIGS. 11A and 11B, it is shown that, e.g., setting items regarding an HR mode and a Cavity/NZ pressure alarm as indicated by dashed lines have been added in the version-B molding condition display program. In this case, although the version of the molding condition display program stored in the storage unit of the injection molding device has been updated to B, if the version of the molding condition program stored in the storage unit of the higher-level management device is A, the form of the molding conditions to be displayed on the injection molding device and the form of the molding conditions to be a played on the higher-level management device are different from each other, leading to a failure to check the contents of the set molding conditions or erroneous setting of the molding conditions. FIG. 12A shows a display screen example when molding conditions are displayed by a version-A molding condition display program. On the other hand, FIG. 12B shows a display screen example when the same molding conditions are displayed by a version-B molding condition display program after arrangement of displayed setting items has been changed due to version update. Referring to FIGS. 12A and 12B, item arrangement is totally different e.g., items regarding injection and items regarding metering. In this case, although the version of the molding condition display program stored in the storage unit of the injection molding device has been updated to B, if the version of the molding condition display program stored in the storage unit of the higher-level management device is A, the form of the molding conditions to be displayed on the injection molding device and the form of the molding conditions to be displayed on the higher-level management device are different from each other, leading to a failure to check the contents of the set molding conditions or erroneous setting of the molding conditions.

Patent Document 1: Japanese Unexamined Patent Application, Publication No. 2004-155125

### DISCLOSURE OF THE INVENTION

### Problems to be Solved by the Invention

On this point, Patent. Document 1 discloses, for example, a molding information management system including an injection molding device 101 and a higher-level computer 110 communicably connected to the injection molding device 101. In the molding information management system, molding condition data 206B and a display control program 206F for display on a display device 112 are stored in a storage unit 206 of the injection molding device 101, the display control program 206F of the injection molding device 101 is executed to transmit a processing result displayed on the display device 112 to the higher-level computer 110, and the higher-level computer 110 displays the same screen as that on the display device 112 of the injection molding device 101 on a display 110a according) the received processing result. However, Patent Document 1 fails disclose a form in which the higher-level computer 110 reads the molding, conditions regarding injection molding from the storage unit and the mold-mg conditions are a played on the display 110a of the higher-level computer 110 by the molding, device molding condition display program stored in advance in the storage unit of the higher-level computer 110. There has been a demand for the technique of displaying the molding conditions in the same form between the injection molding device and the high-level management device even in a case where molding condition display program of the injection molding device has been changed due to, e.g., function addition or a change in the model of the injection molding, device.

### Means for Solving the Problems

One aspect of a molding condition display system of the present disclosure is a molding condition di system including an injection molding device having a display and a management device having a display device, the management device being communicably connected to the injection molding device. The injection molding device has a storage unit that stores a first molding condition display program to be executed in the injection molding device to display a molding condition stored in the injection molding device on the display and a second molding condition display program, which corresponds to the first molding condition display program, to be executed in the management device to display a molding condition stored in the management device on the display device of the management device, and a transmission unit that transmits the second molding condition display program from the storage unit of the injection molding device to the management device. The management device has a reception unit that acquires the second molding condition display program from the injection molding device.

One aspect of the molding condition di Splay system of the present disclosure is a molding condition display system including an injection molding device having a display and a management device having a display device, the management device being communicably connected to the injection molding device. The management device has a storage unit that stores a first molding condition display program to be executed in the injection molding device to display a molding condition stored in the injection molding device on the display of the injection molding device and a second molding condition display program, which corresponds to the first molding condition display program, to be executed in the management device to display a molding condition stored in the management device on the display device of the management device, and a transmission unit that transmits the first molding condition display program to the injection molding device. The injection molding device has a reception unit that acquires the first molding condition display program from the management device.

One aspect of a molding condition display program storage medium of the present disclosure is a storage medium for inputting, to an injection molding device and a management device, a molding condition di program for displaying a molding condition on the injection molding device including a display and the management device including a display device, the management device being communicably connected to the injection molding device. The molding condition display program includes a first molding condition c splay program to be executed in the injection molding device to display a molding condition stored in the injection molding device on the display or the infection molding device and a second molding condition display program, which corresponds to the first molding condition display program, to be executed in the management device to display a molding condition stored in the management device on the display device of the management device.

One aspect an injection molding a device of the present disclosure is an injection molding device communicably connected to a management device including a display device. The injection molding device includes a display, a storage unit that stores a first molding condition display program to be executed in the injection molding device to display molding condition stored in the injection molding device on the display and a second molding condition display program, which corresponds to the first molding condition display program, to be executed in the management device to display a molding condition stored in the management device on the display device of the management device, and a transmission unit that transmits the second molding condition display program from the storage unit of the injection molding device to the management device.

One aspect of a management device of the present disclosure is a management device communicably connected to an injection molding device including a display. The management device includes a display device, a storage unit that stores a first molding condition display program to be executed in the injection molding device to display a molding condition stored in the injection molding device on the display of the injection molding device and a second molding condition display program, which corresponds to the first molding condition display program, to be executed in the management device to display a molding condition stored in the management device on the display device of the management device, and a transmission unit that transmits the first molding condition display program to the injection molding device.

### Effects of the Invention

According to one aspect, the molding condition can be displayed in the same form between the injection molding device and the higher-level management device.

### BRIEF DESCRIPTION OF THE DRAWINGS

FIG. 1 is a diagram showing the configuration of a molding condition display system according to a first embodiment;

FIG. 2 is a diagram showing the configuration of an injection molding, device according to the first embodiment;

FIG. 3 is a view showing one example of indications of molding conditions regarding injection; metering;

FIG. 4 is a diagram showing the configuration of a management device according to the first embodiment;

FIG. 5 is a view showing one example of the configuration of a relationship table according to the first embodiment;

FIG. 6 is a flowchart for describing operation of the injection molding device 1 and operation of the management device 2 in the first embodiment;

FIG. 7 is a diagram showing the configuration of a molding condition display system according to a second embodiment;

FIG. 8 is a diagram showing the configuration of a management device according to the second embodiment;

FIG. 9 is a diagram showing the configuration of an injection molding device according to the second embodiment;

FIG. 10 is a flowchart for describing operation of the management device and operation of the injection molding device in the second embodiment;

FIG. 11A is a view showing one example of indications of molding conditions regarding injection/metering in a case where the version of a molding condition display program is a predetermined number;

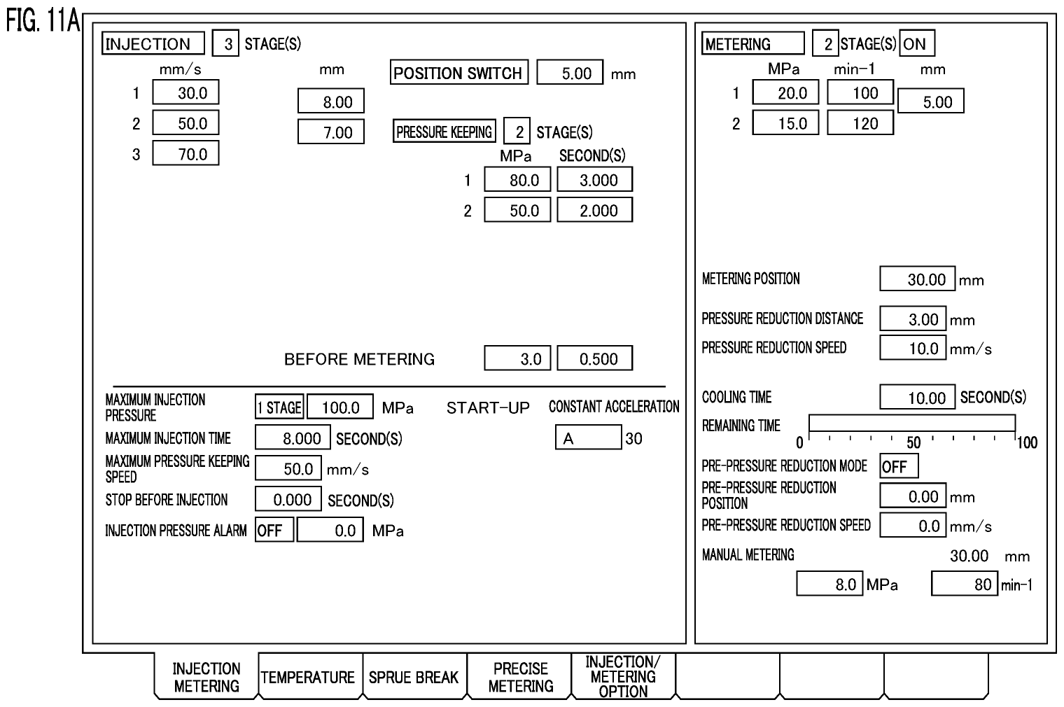

FIG. 11B is a view showing one example of the indications of the molding conditions regarding injection/metering in a case where the version of the molding condition display program has been changed;

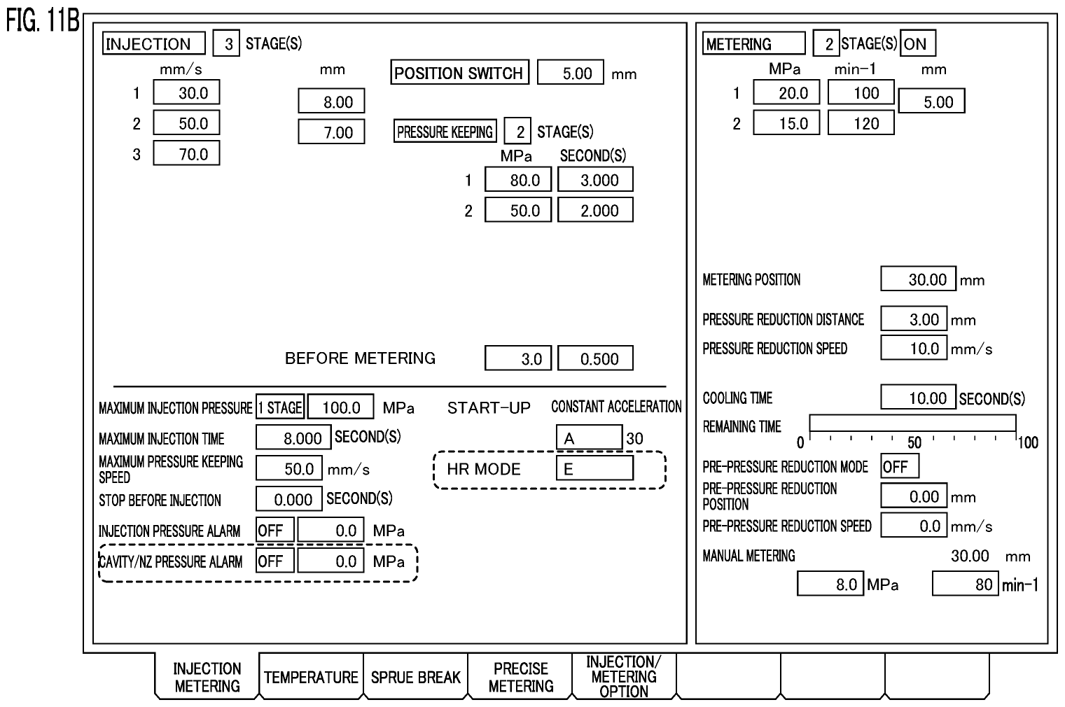

FIG. 12A is a view showing one example of indications of molding conditions regarding injection/metering in a case where the version of a molding condition display program is a predetermined number; and

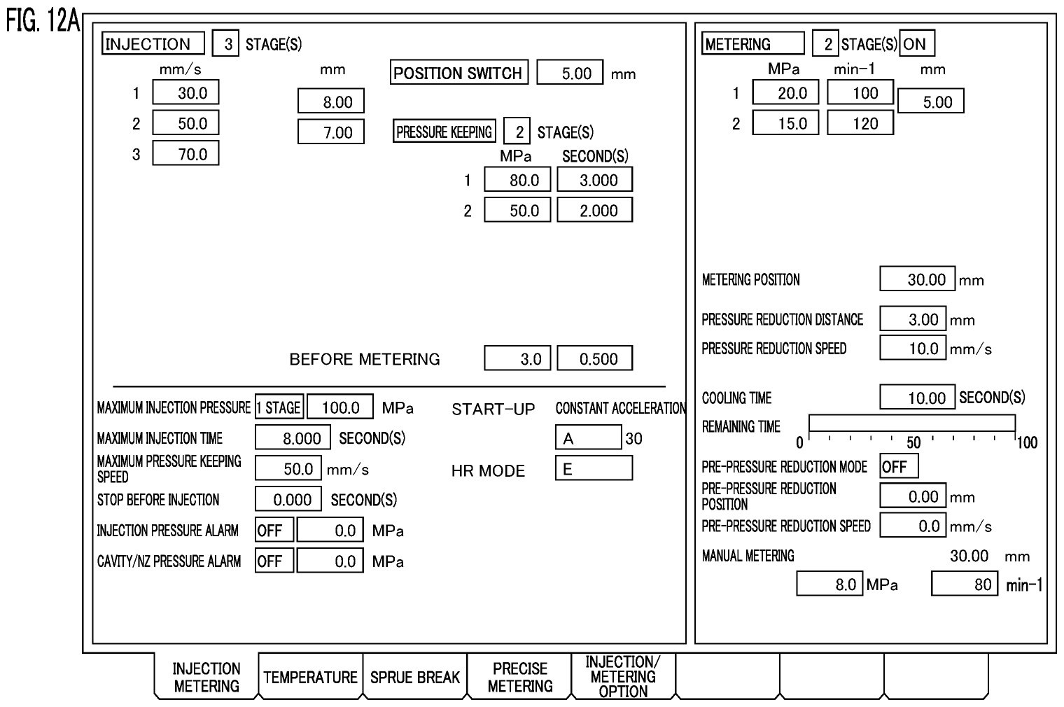

FIG. 12B is a view showing one example of the indications of the mold in conditions regarding injection/metering in a case where the version of the molding condition display program has been changed.

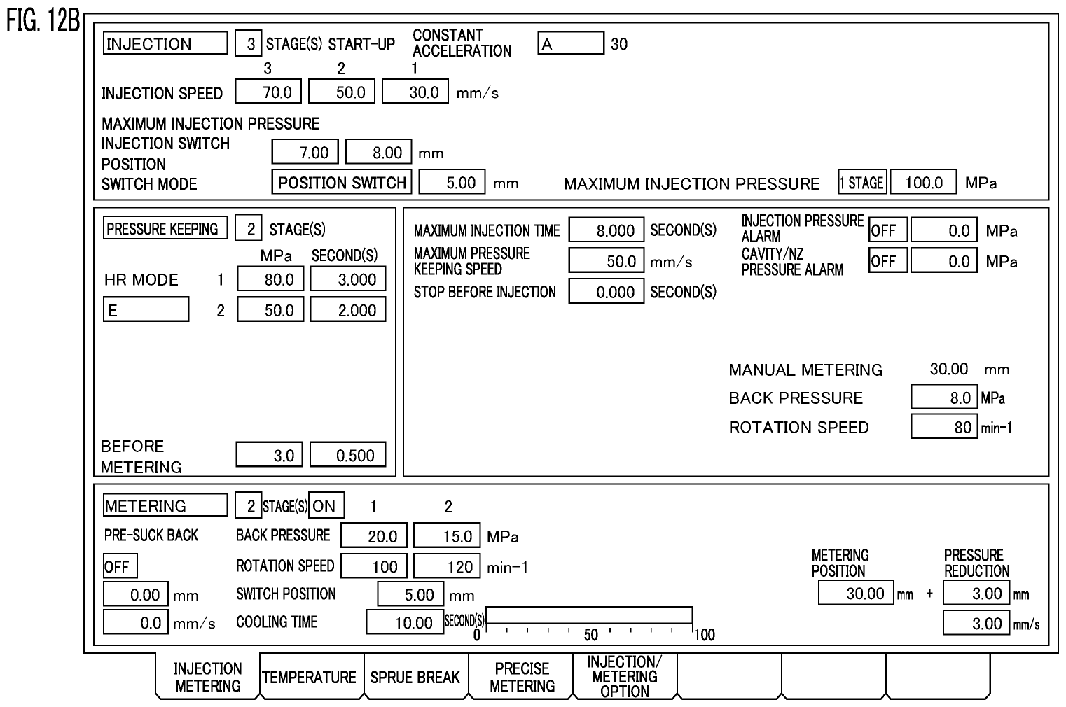

### PREFERRED MODE FOR CARRYING OUT THE INVENTION

### First Embodiment

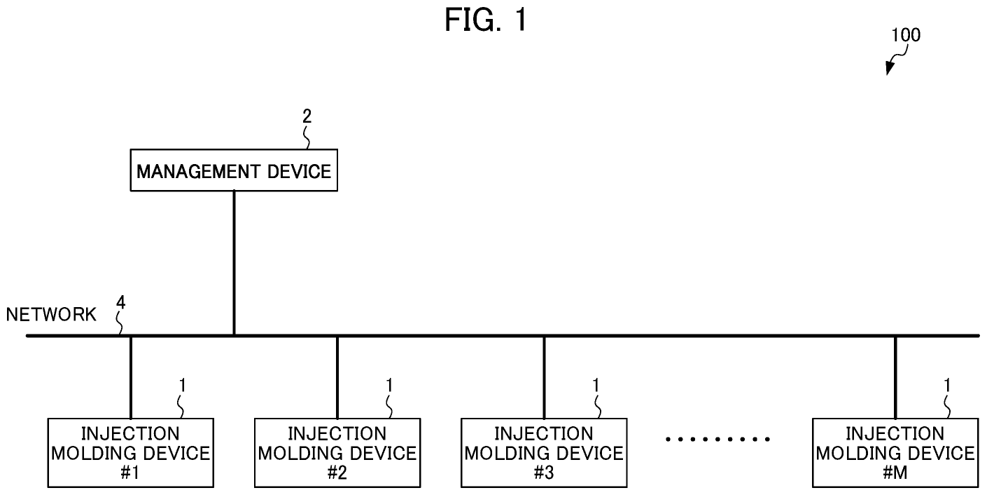

Hereinafter, a functional configuration a molding condition display system according to one preferred embodiment of the present invention will be described with reference to the drawings. FIG. 1 is a diagram showing a system configuration of the molding condition display system. A first embodiment describes, as an example, a form in which a first molding condition display program to be executed in an injection molding device 1 to display molding conditions stored in the injection molding device 1 on a display 14 of the injection molding device 1 and a second molding condition display program, which corresponds to the first molding condition display program, to be executed in a management device 2 to display molding conditions stored in the management device 2 on a display device of the management device 2 are managed in a unified manner.

FIG. 1 is the diagram showing the configuration of the molding condition display system according to the present embodiment. As shown in 1, the molding condition di system 100 includes injection molding devices placed in a molding plant, the management device 2, and a network 4. In description below, the plurality of injection molding devices 1 will be described as an example. Moreover, an intra-molding-plant network 4 (e.g., LAN) will be described as an example of the network 4, but the first embodiment is not limited to above. For example, a single injection molding device 1 may be employed. The network 4 may include an optional communication network (e.g., an optional wide area network including the Internet etc.).

### [Injection Molding Device 1]

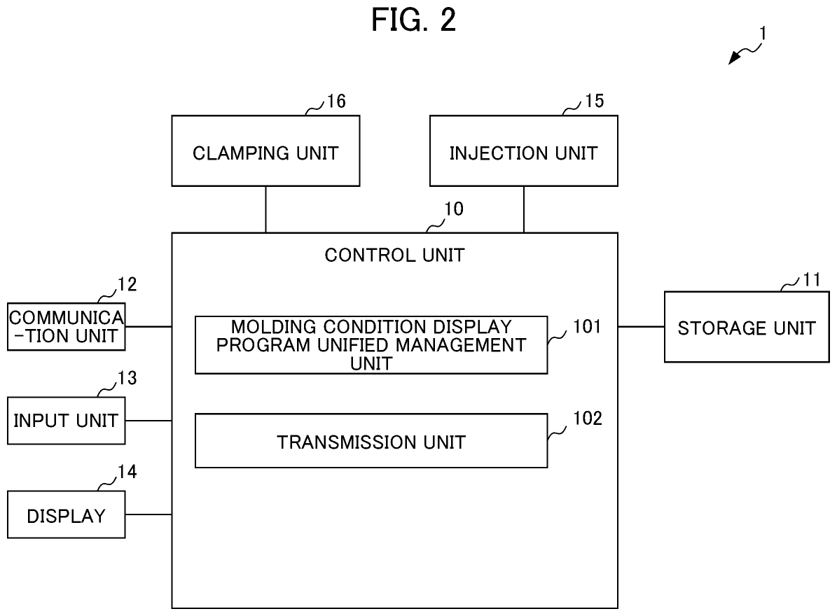

FIG. 2 diagram showing the configuration of the injection molding device according to the first embodiment. As shown in FIG. 2, the injection molding device 1 includes a control unit 10, a storage unit 11, a communication unit 12, an input unit 13, the display 14, an injection unit 15, and a clamping unit 16.

The control unit 10 includes, for example, a microprocessor, and executes each program read from the storage unit 11 to control the injection unit 15, the clamping unit 16, etc. and manage the later-described molding condition display programs in a unified manner. Moreover, when executing each program read from the storage unit 11, the control unit 10 reads information from, the storage unit 11 and writes information in the storage unit 11, thereby controlling the communication unit 12, the input unit 13, the display 14, the Injection unit 15, the clamping unit 16, etc. Details of the control unit 10 will be described later.

The storage unit 11 includes, for example, a semiconductor memory and a hard disk drive, and stores various programs such as a sequence program for controlling sequence operation of the injection molding device 1, a motion axis control program for drivably controlling each axis of the injection molding device 1, and a servocontrol program for controlling a servomotor for each axis, molding conditions and various set values regarding an injection molding process, molding data such as parameters and macro variables, and injection molding device operation information, for example. Moreover, the storage unit 11 stores the first molding condition display program to be executed in the injection molding device 1 to display the molding conditions stored in the injection molding device 1 on the display 14 and the second molding condition display program, which corresponds to the first molding condition display program, to be executed in the management device to display the molding conditions stored in the management device 2 on the device of the management device 2.

The communication unit 12 is provided targeted for, e.g., LAN, and data-communicates with the management device 2 via the intra-molding-plant network in response to an instruction from the control unit 10. The input unit 13 includes, for example, an input device such as a keyboard or a touch panel provided to overlap with a display surface of the 14, an IC card reader, a bar-code reader, and an IC tag reader. The display 14 includes, for example, a display device such as a liquid crystal display, and displays a screen in response to an instruction from the control unit 10.

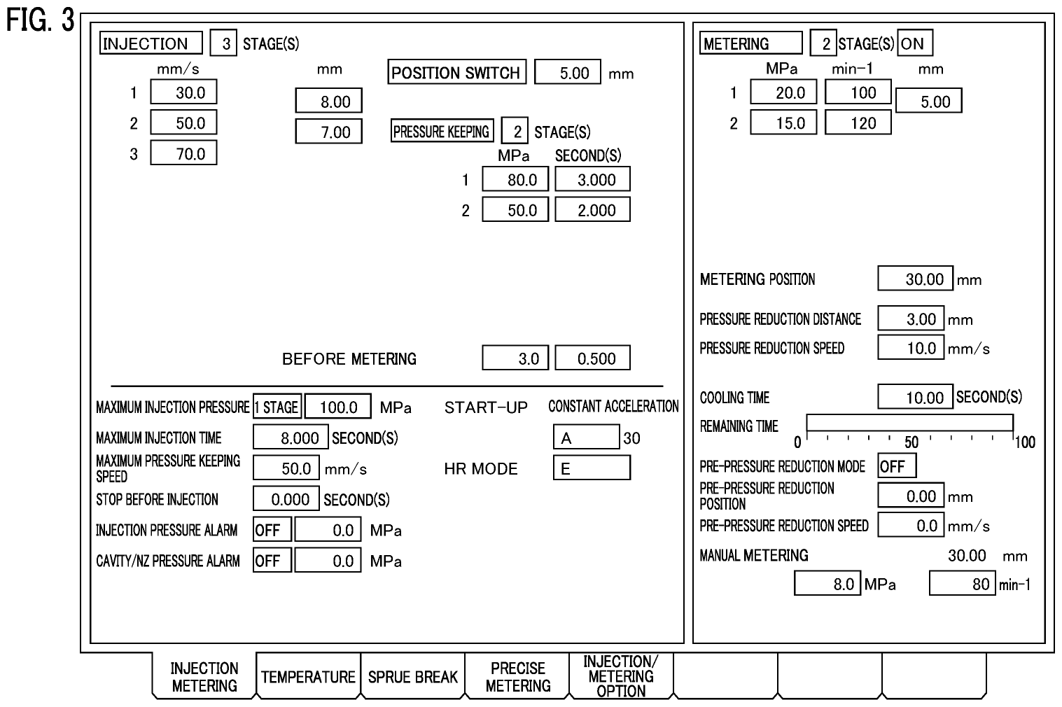

The control unit 10 includes, for example, the microprocessor, and controls each component. The control unit 10 includes well known functional units of the injection molding device 1, such as a sequence control unit. (not shown) that controls the sequence operation of the injection molding device 1, a motion axis control unit (not shown) that drivably controls each axis of the injection molding device 1, and a servocontrol unit (not shown) that controls the servomotor for each axis. Moreover, the control unit 10 executes the first molding condition display program, hereby displaying the molding conditions stored in the storage unit 11 etc. on the display 14. FIG. 3 is a view showing one example of indications of molding conditions regarding injection/metering among the injection molding conditions. Note that the indications of the molding conditions may include, in addition to the molding conditions regarding injection/metering, indications (not shown) of molding conditions regard ng temperature setting, indications (not shown) of molding conditions regarding die operation/ejection sett ng, and indications (not shown) regarding peripheral equipment communication, for example. These molding conditions are well by those skilled in the art, and therefore, detailed description thereof will be omitted. In addition to these functions, the control unit 10 includes a molding condition display program unified management unit 101 and a transmission unit 102 as shown in FIG. 2.

The molding condition display program unified management unit 101 manages, as the same version, the first molding condition display program to be executed in the injection molding device 1 and the second molding condition display program to be executed in the management device 2, the indications of the molding conditions being in the same display form between the injection molding device 1 and the management device 2. Note that version information for managing the first molding condition display program and the second molding condition display program includes Inform on on the model of the injection molding device 1. The model information described herein may include identification information (ID) on the injection molding device 1 and/or specification identification information for identifying the specifications (including, e.g., a model number) of the injection molding device 1. With this configuration, even in case where the injection molding devices 1 are different from each other in the identification information (ID), if these injection molding devices 1 have the same specification identification information the same specifications), the first molding condition di program and the second molding condition display program can be taken as the same version.

In order to manage, as the same version, the first molding condition display program and the second molding condition display program such that the indications of the molding conditions are in the same display form between the Injection molding device 1 and the management device 2, the first molding condition display program and the second molding condition display program may be customized and generated so as to operate on the injection molding device 1 and the management device 2 based on the same source code, and in this manner, the indications of the molding conditions may be in the same display form, for example. Alternatively, the first molding condition display program and the second molding condition display program may be generated to select the injection molding device 1 or the management device 2 as a molding condition file reading destination when operating on the injection molding device 1 and the management device 2 based on the same source code, for example. Note that the method for producing the first molding condition display program and the second molding condition display program such that the indications of the molding conditions are in the same display form is not limited to above. An optional method for producing the first molding condition display program and the second molding condition display program such that the indications of the molding conditions are in the same display form may be employed.

The transmission unit 102 transmits the second molding condition display program corresponding to the first molding condition display program from the storage unit. 11 to the management device 2 via the communication unit 12 based on a preset trigger.

Specifically, the transmission unit 102 may transmit, as a push notification, a second molding condition display program corresponding to the changed latest version to the management device 2, taking a change in the version of the first and second molding condition display programs managed in a unified manner in the molding condition display program unified management unit 101 as a trigger, for example. In this case, the transmission unit 102 may move, together with the latest version information, the second molding condition display program to the management device 2. Alternatively, the transmission unit 102 may transmit a duplicate (copy) of the second molding condition display program to the management device 2.

Taking a request for transmission of the second molding condition display program from the management device 2 as a trigger, the transmission unit 102 may transmit the second molding condition display program to the management device 2. In this case, information on the version of the second molding condition display program in operation in the management device 2 may be included as transmission request information. With this configuration, the injection molding device 1 may transmit the latest second molding condition display program to the management device 2 only in a case where the version information included in the transmission request information is not the latest.

Taking new execution of injection molding in the Injection molding device 1 as a trigger, the transmission unit 102 may transmit the latest second molding condition display program to the management device 2. As described above, in the first embodiment, each injection molding device 1 manages the first molding condition display program and the second molding condition display program in a unified manner so that the form of the molding conditions to be displayed can be the same between the Injection molding device 1 and the higher-level management device 2. The injection molding device 1 in the first embodiment has been described above. Next, the management device 2 in the first embodiment will be described.

### [Management Device 2]

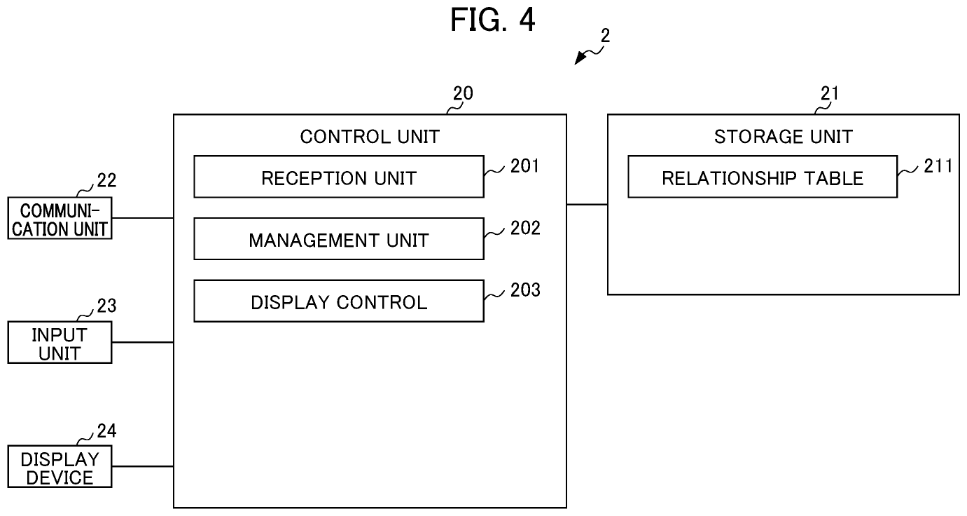

FIG. 4 is a diagram showing the configuration of the management device according to the first embodiment. As shown in FIG. 4, the management device 2 includes a control unit 20, a storage unit 21, a communication unit 22, an input unit 23, and the display device 24.

The control unit 20 includes, for example, a microprocessor, and executes each program read from the storage unit 21 to receive the second molding condition display program from the injection molding device 1 and manage a correspondence with such an in; action molding device 1 (the first molding condition display program). Moreover, the control unit 20 can display processing conditions regarding the injection molding device 1 in the same form as that in such an injection molding device 1 on the display device 24 of the management device Details of the control unit 20 will be described later.

As described above, the storage unit 21 can store the backup of the molding conditions in each injection molding device 1 in association with such an injection molding device 1. Moreover, the storage unit 21 stores the second molding condition display program corresponding to the injection molding device 1 (the first molding condition display program). Specifically, as described later, the second molding condition display program received from the injection molding device 1 by a reception unit 201 is stored in association with the first molding, condition display program of such an in molding device 1. For storage in association with the program, the storage unit 21 may include, for example, relationship table 211 that associates the name of the second molding condition display program with the version information on the name of the first molding condition display program. The relationship table 211 will be described later together with a management unit 202.

The communication unit 22 is provided targeted for, e.g., LAN, and data-communicates with the injection molding device 1 via the intra-molding-plant network in response to an instruction from the control unit 20. The input unit 23 includes, for example, an input device such as a keyboard or a touch panel provided to overlap with a display surface of the display device 24, an IC card reader, a bar-code reader, and an IC tag reader. The display device 24 includes, for example, a display device such as a liquid crystal display, and displays a screen in response to an instruction from the control unit 20.

The control unit 20 executes each program read from the storage unit 21, thereby causing the control unit 20 to function as a predetermined functional unit (collectively referred to as an “injection molding device management unit”). Moreover, the control unit 20 executes the second molding condition display program, thereby displaying the molding conditions stored in the storage unit 21 on the display device 24, as described above. Note that the screen displayed on the display device 24 is in the same form as that of the screen displayed on the display 14 of the injection molding device 1. Thus, the control unit 20 includes the reception unit 201, the management unit 202, and a display control unit 203, as shown in FIG. 4.

The reception unit 201 receives the second molding condition display program corresponding to the first molding condition display program together with the version information including the information on the model of the injection molding device 1 from the injection molding device 1 via the communication unit 22, and stores the program and the information in the storage unit 21. In the case of transmitting, as the push notification, the second molding condition display program from the injection molding device 1 as described above, the reception unit 201 receives the second molding condition display program together with the version information including the information on the model of the injection molding device 1. As described above, the reception unit 201 may request the injection molding device 1 to transmit the latest second molding condition display program, thereby receiving the latest second molding condition display program from the injection molding device 1. As described above, the reception unit 201 may receive the latest second molding condition display program from the injection molding device 1, taking new execution of injection molding in the injection molding device 1 as a trigger. With this configuration, the management device 2 can constantly store, in the storage unit 21, the latest second molding condition display program corresponding to the first molding condition display program in association with the version information including the information on the model of the injection molding device 1.

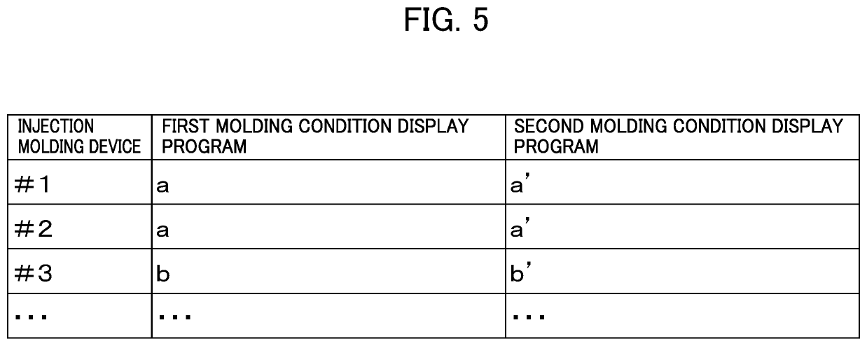

The management unit 202 manages the second molding condition display program corresponding to each injection molding device 1 (the first molding condition display program). Specifically, the management unit 202 produces and updates, in the later-described storage unit 21, the relationship table 211 that associates the second molding condition display program with the information on the model of the injection molding device 1 every time the reception unit 201 receives the second molding condition di ay program from the injection molding device 1, for example. Note that in the case of utilizing the identification information (ID) on the injection molding device 1 as the model information second molding condition display program may be associated with each injection molding device 1. In the case of utilizing the specification identification information on the injection molding device 1 as the model information, the second molding condition display program may be associated with the injection molding devices 1 with the same specifications. FIG. 5 is a view showing one example of the relationship table. As shown in FIG. 5, the identification information (ID) on the injection molding device 1, the name of the first molding condition display program, and the name of the second molding condition display program may be associated with each other. Referring to FIG. 5, the same molding condition di ay programs (the first molding condition display program and the second molding condition display program) are applied to an injection molding device #1 and an injection molding device #2. In a case where the management device 2 is communicably connected to the plurality of injection molding devices 1 as described above, the second molding condition display program corresponding to each injection molding device 1 (the first molding condition display program) can be managed. In the case of specifying the injection molding device 1 via the input unit 23 of the management device 2, the management unit 202 may further specify the second molding condition display program corresponding to such an injection molding device 1 (the first molding condition display program) from the storage unit 21.

The display control unit 203 executes the second molding condition display program (corresponding to the first molding condition display program), thereby displaying the molding conditions (of the injection molding device 1) stored in the storage unit 21 on the display device 24. Specifically, the display control unit 203 executes the second molding condition display program specified by the management unit 202, thereby displaying the molding conditions on the display device 24 in the same form as that of the molding conditions displayed on the display 14 of the injection molding device 1. The management device 2 in the first embodiment has been described above. Next, operation of the injection molding device 1 and the management device 2 according to the first embodiment will be described.

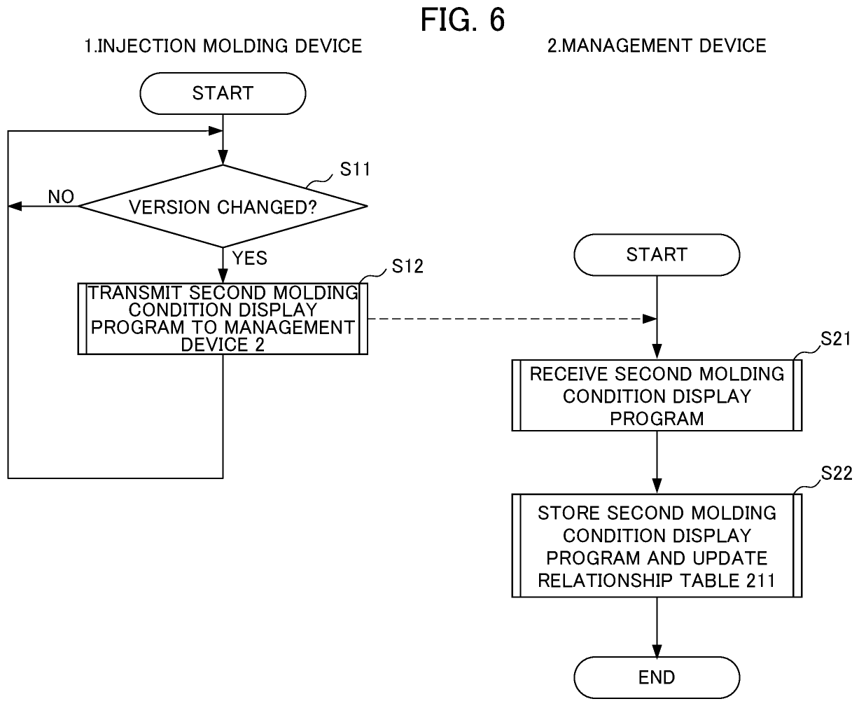

FIG. 6 is a flowchart for describing operation (the processing transmitting the second molding condition display program corresponding to the first molding condition display program to the management device 2 with no delay) of the injection molding device 1 and operation until the second molding condition display program is stored in the storage unit 21 after the management device 2 has received the second molding condition display program. The following processing will be described herein as an example: the second molding condition display program corresponding to the changed latest version is, as a push notification, transmitted to the management device 2, taking a change in the version of the first and second molding condition display programs managed in a unified manner in the injection molding device 1 as a trigger.

Referring to FIG. 6, in Step S11, the injection molding device 1 (the molding condition display program unified management unit 101) determines whether or not the version of the first molding condition display program and the second molding condition display program has been changed. If changed (in the case of YES), the processing proceeds to Step S12. If not changed (in the case of NO), the processing returns to Step S11.

In Step S12, the injection molding device 1 (the transmission unit 102) transmits, together with the version information, the second molding condition display program to the management device 2. Thereafter, the processing proceeds to Step S21.

In St S21, the management device 2 receives the second molding condition display program together with the version information.

In Step S22, the management device 2 stores the second molding condition display program, and updates the relationship table 211 based on the received version information.

By the above-described steps, the injection molding device 1 of the first embodiment can guarantee that the form of the molding conditions to be displayed is the same between the in molding device 1 and the management device 2.

### Second Embodiment

The first embodiment has described, as an example, the form in which the first molding condition display program and the second molding condition display program are managed in a unified manner in the injection molding device 1. However, a second embodiment will describe, as an example, a form in which a first molding condition display program and a second molding condition display program are managed in a unified manner in a management device 2. Differences from the first embodiment will be mainly described in the second embodiment. Thus, the same reference numerals are used to represent the same (or similar) configurations as those of the first embodiment, and detailed description thereof will be omitted. Moreover, for points not specifically described in the present embodiment, description of the first embodiment is applied as necessary. Unless otherwise provided, advantageous effects similar to those of the first embodiment are also provided in the second embodiment.

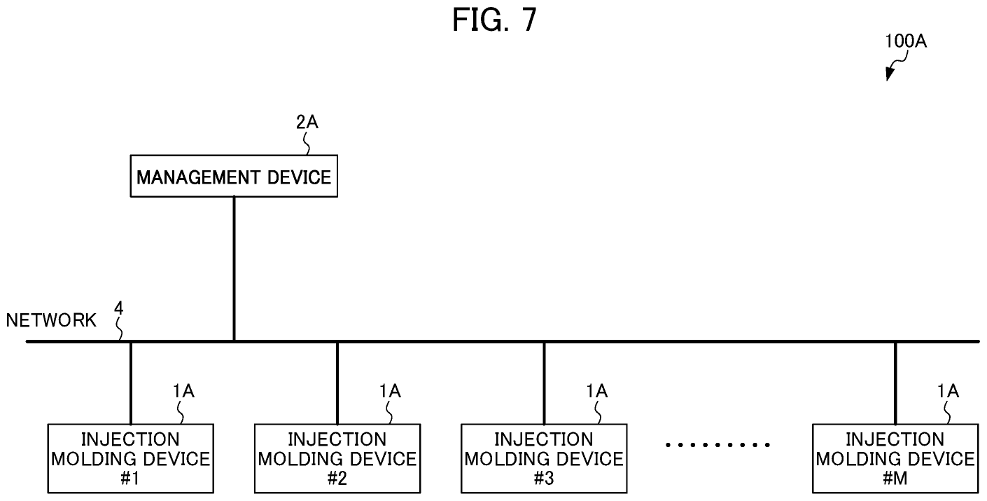

As described above, the second embodiment is different from the First embodiment in that the first molding condition display program and the second molding condition display program are managed in a unified manner in a management device 2A. FIG. 7 is a diagram showing a system configuration of a molding, condition display system 100A in the second embodiment. As shown in FIG. 7, the molding condition display system 100A includes injection molding devices 1A placed in a molding plant, the management device 2A, and a network 4.

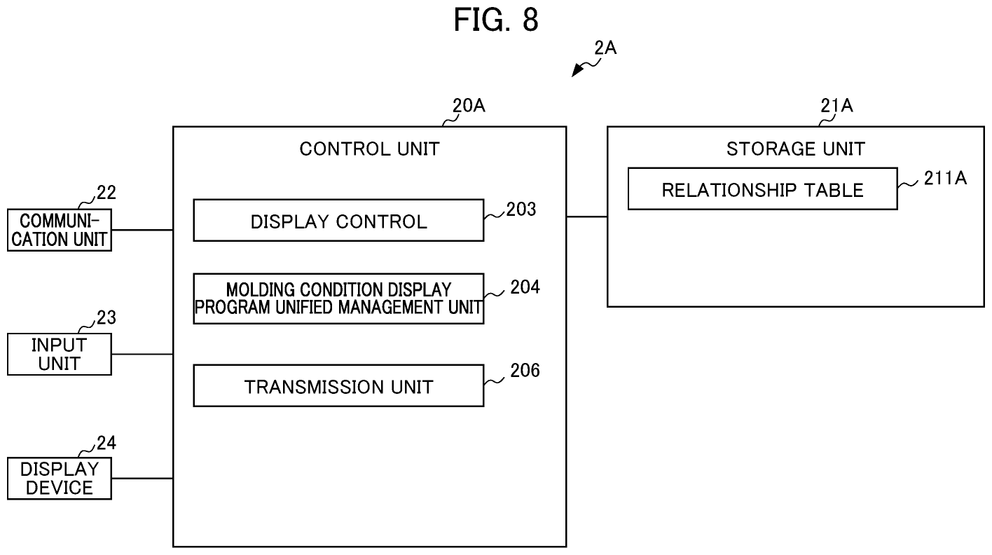

FIG. 8 is a diagram showing the configuration of the management device 2A according to the second embodiment. As shown in FIG. 8, the management device 2A includes a control unit 20A, a storage unit 21A, a communication unit 22, an input unit 23, and a display device 24.

As described above, the storage unit 21A can store the backup of molding conditions in each injection molding device 1A in association with, e.g., such an injection molding device 1A. Moreover, the storage unit 21A stores the first molding condition display program for displaying the molding conditions stored in the injection molding device 1A on a display 14 of the injection molding device 1A and the second molding condition display program, which corresponds to the first molding condition display program, for displaying molding conditions stored in the management device 2A on the display device 24 of the management device 2A in association with each other. Specifically, the storage unit 21A may include, for example, a relationship table 211A that associates the name of the first molding condition display program and the name of the second molding condition display program with version information. The relationship table 211A may be a table that associates the version information including information on the model of the injection molding device 1A, the name of the first molding condition display program, and the name of the second molding condition display program with each other. With this configuration, a later-described molding condition display program unified management unit 204 may manage the first molding condition display program and the second molding condition display program in a unified manner based on the relationship table 211A. Note that as in the first embodiment, the version information includes the information, which corresponds to the first molding condition display program, on the model of the injection molding device 1A. The model information described herein may include identification information (ID) on the injection molding device 1A and/or specification identification information corresponding to the specifications of the injection molding device 1A.

As shown in FIG. 8, the control unit 20A includes a display control unit 203, the molding condition display program unified management unit 204, and a transmission unit 206. The display control unit 203 has a function equivalent to that of the display control unit 203 described in the first embodiment. Specifically, the display control unit 203 executes the second molding condition display program specified by the later-described molding condition display program unified management unit 204 so that the form of the molding conditions stored in the storage unit 21 and displayed on the display device 24 can be the same as the form of the molding, conditions displayed on the display 14 of the injection molding device 1A.

The molding condition display program unified management unit 204 manages, as described above, the first molding condition display program to be executed on the injection molding device 1A and the second molding condition display program to be executed on the management device 2A in a unified manner based on the relationship table 211A, the first molding condition display program and the second molding condition display program being in the same display form upon display of the molding conditions. Specifically, the molding condition display program unified management unit 204 updates the relationship table 211A in the case of updating the version of the first molding condition display program corresponding to a certain injection molding device 1A and the second molding condition display program (i.e., a case where the version has been changed). Accordingly, the injection molding device 1A executing the first molding condition display program corresponding to the updated latest version can be specified. At the same time, the first and second molding condition display programs updated based on the updated version can be managed. Note that the method for generating the first molding condition display program and the second molding condition display program, program structures, etc. for managing the first molding condition program and the second molding condition display program as the same version are the same as those of the first embodiment.

The molding condition display program unified management unit 204 refers to the relationship table 211A so that the latest first molding condition display program corresponding to an optional injection molding device 1A can be specified. For example, in a case where the first molding condition display program corresponding to the injection molding device 1A and the second molding condition display program are updated, the molding condition display program unified management unit 204 can specify the injection molding device 1A executing the first molding condition display program corresponding to the updated latest version based on the relationship table 211A.

For example, taking a change in the first and second molding condition display programs managed in a unified manner in the management device 2A (the molding condition display program unified management unit 204) as a trigger, the transmission unit 206 may transmit, as a push notification, the first molding condition display program corresponding to the changed latest version to the injection molding device 1A specified based on the relationship table 211A. In this case, the transmission unit 206 may move, together with the latest version information, the first molding condition display program to the injection molding device 1A. Alternatively, the transmission unit 206 may transmit the duplicate (copy) of the first molding condition display program to the injection molding device 1A.

Taking a request for transmission of the first mold in; condition display program from the injection molding device 1A as a trigger, the transmission unit 206 may transmit the first molding condition display program to the injection molding device 1A. In this case, the information on the version of the first molding condition display program in operation in the injection molding device 1A may be included as transmission request information. With this configuration, the management device 2 may transmit the latest first molding condition display program the injection molding device 1A only in a case where the version information included in the transmission request information is not the latest.

Taking new execution of injection molding in the Injection molding device 1A as a trigger, the transmission unit 206 may transmit the latest first molding condition display program to the injection molding device 1A based on the transmission request from the injection molding device 1A. As described above, in the second embodiment, the management device 2A manages the first molding condition display program and the second molding condition display program in a unified manner so that the form of the molding conditions to be displayed can be the same between the lower-level injection molding device 1A and the management device 2. The management device 2A in the second embodiment has been described above. Next, the injection molding device 1A in the second embodiment will be described.

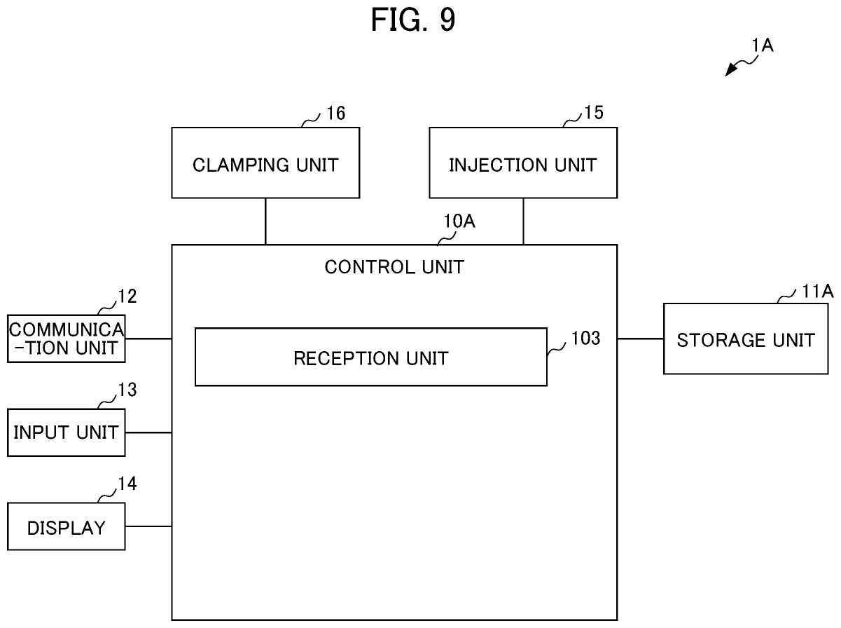

FIG. 9 is a diagram showing the configuration of the injection molding device 1A according to the second embodiment. As shown in FIG. 9, the injection molding device 1A includes a control unit 10A, a storage unit 11A, a communication unit 12, an input unit 13, the display 14, an injection unit 15, and a clamping unit 16.

The control unit 10A includes, for example, a microprocessor, and executes each program read from the storage unit 11A to control the injection unit 15, the clamping unit 16, etc. Moreover, the control unit. 10A executes the first molding condition display program, thereby displaying, e.g., the molding conditions stored in the storage unit 11A on the display 14 of the injection molding device 1A. Details of the control unit 10A will be described later.

The storage unit 11A includes, for example, a semiconductor memory and a hard disk drive, and stores various programs such as a sequence program for controlling sequence operation of the inject ion molding device a motion axis control program for drivably controlling each axis of the injection molding device 1A, and a servocontrol program for controlling a servomotor for each axis, molding conditions and various set values regarding an injection molding process, molding data such as parameters and macro variables, and injection molding device operation information, for example. Moreover, the storage unit 11A stores the first molding condition display program.

The communication unit 17 is provided targeted for, e.g., LAN, and data-communicates with the management device 2A via an intra-molding-plant network in response to an instruction from the control unit 10A. The input unit 13 includes, for example, an input device such as a keyboard or a touch panel provided to overlap with a display surface of the display 14, an IC card reader, a bar—code reader, and an IC tag reader. The display 14 includes, for example, a display device su n as a liquid crystal display, and d s a screen in response to an instruction from the control unit 10A. For example, the display 14 displays the molding conditions stored in the storage unit 11A in such a manner that the control unit 10A executes the first molding condition display program.

As described above, the control unit 10A includes, for example, the microprocessor, and controls each component. The control unit 10A includes well-known functional units of the injection molding device 1A, such as a sequence control unit (not shown) that controls the sequence operation of the injection molding device 1A, a motion axis control unit (not shown) that drivably controls each axis of the injection molding device 1A, and a servocontrol unit t shown) that controls the servomotor for each axis. Moreover, as described above, the control unit 10A executes the first molding condition display program, thereby displaying the molding conditions stored in the storage unit 11A on the display 14. Further, in addition to these functions, the control unit 10A includes a reception unit 103 as shown in FIG. 9.

The reception unit 103 receives the first molding condition display program together with the version information including the information on the model of the injection molding device 1A from the management device 1A via the communication unit 12, and stores the program and the information in the storage unit 21A. As described above, in the case of transmitting, as the push notification, the first molding condition display program from the management device 2A, the reception unit 103 receives the first molding condition display program together with the version information including the information on the model of the injection molding device 1A. As described above, the reception unit 103 may request the management device 2A to transmit the latest first molding condition display program, thereby receiving the latest first molding condition display program from the management device 2A. As described above, the reception unit 103 may receive the latest first molding condition display program from the management device 2A, taking new execution of injection molding in the injection molding, device 1A as a trigger. With this configuration, le injection molding device 1A can constantly store, in the storage unit 11A, the latest first molding condition display program in association with the version information including the information on the model of the injection molding device 1A. The injection molding device 1A in the second embodiment has been described above. Next, operation of the injection molding device 1A and the management device 2A ng the second embodiment will be described.

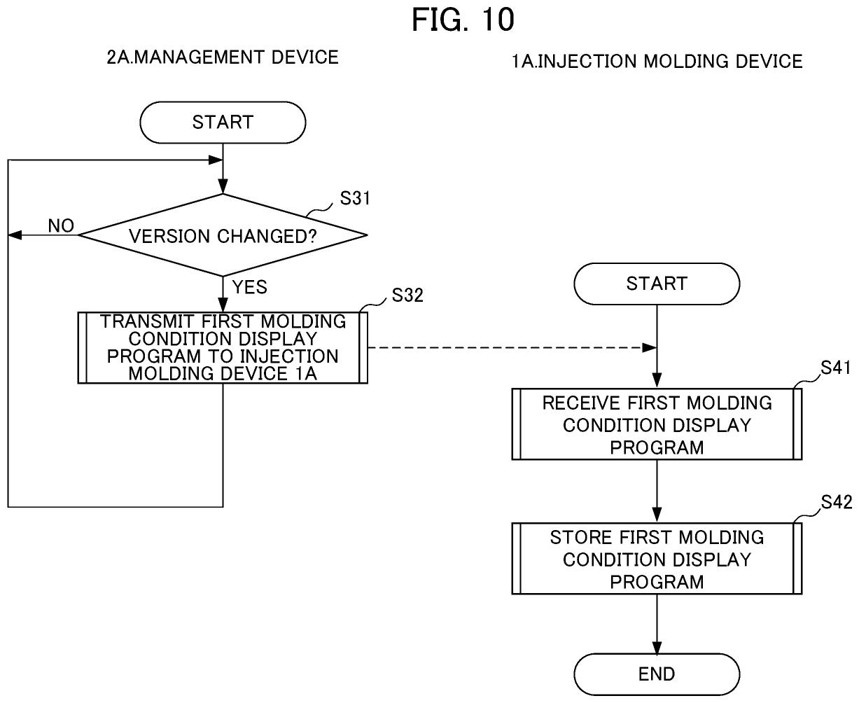

FIG. 10 is a flowchart for describing operation (the processing of transmitting the first molding condition display program to the injection molding device 1A with no delay) of the management device 2A and operation until the first molding condition display program is stored in the storage unit. 11A after the injection molding device 1A has received the first molding condition display program. The following processing will be described herein as an example: the first molding condition display program corresponding to the changed latest version is, as a push notification, transmitted to the injection molding device 1A, taking a change in the version the first and second molding condition display programs managed in a unified manner in the management device 2A as a trigger.

Referring to FIG. 10, in Step S31, the management device 2A (the molding condition display program unified management unit 204) determines whether or not the version of the first molding condition display program and the second molding condition display program has been changed. If changed (in the case of YES), the processing proceeds to Step S32. If not changed (in the case of NO), the processing proceeds to Step S31.

In Step S32, the management device 2A (the transmission unit 206) transmits, together with the version information, the first molding condition display program to the injection molding device 1A. Thereafter, the processing proceeds to Step S41.

In Step S41, the injection molding device 1A receives the first molding condition display program together with the version information. In Step S42, the injection molding device 1A stores the first molding condition display program together with the version information in the storage unit 11A.

The above—described steps can guarantee that the form of the molding conditions to be displayed is the same between the injection molding device 1A and the management device 2A of the second embodiment.

The embodiments of the present invention have been described above, but the present invention is not limited to the above-described embodiments. The advantageous effects described in the present embodiments merely include the list of those most suitable in the present invention, and the advantageous effects of the present invention are not limited to those described in the present embodiments.

### <Variation 1>

The first embodiment has described, as an example, the form in which the second molding condition display program is transmitted from the injection molding device 1 to the management device 2 via the network 4, and the second embodiment has described, as an example, the form in which the first molding condition display program is transmitted from the management device 2A to the injection molding device 1A via the network 4. On the other hand, the first molding condition display program and the second molding condition display program may be exchanged between the injection molding device and the management device via a storage medium, specifically, the first molding condition display program and the second molding condition display program may be exchanged between the injection molding device (1, 1A) and the management device (2, 2A) by means of a molding condition display program tor age medium including the first molding condition display program for displaying the molding conditions stored in the injection molding device (1, 1A) on the display 14 of such an injection molding device and the second molding condition display program, which corresponds to the first molding condition di program, for displaying the molding conditions stored in the management device (2, 2A) on the display device 24 of such a management device, for example.

### <Variation 2>

Each of the first embodiment and the second embodiment has described, as an example, the form in which the first molding condition display program and the second molding condition display program are managed in a unified manner in the injection molding device 1 or the management device 2A. On the other hand, the first molding condition display program and the second molding condition display program may be managed in a unified manner in another type of information equipment (e.g., a PC or a server), and may be transmitted to the injection molding device 1 and the management device 2 via the network, for example. The molding condition display program storage medium including the first molding condition display program and the second molding condition display program as described in Variation 1 may be generated in another type of information equipment (e.g., a PC or a server), and the first molding condition display program and the second molding condition display program may be input to the injection molding device and the management device via such a storage medium.

### <Variation 3>

The present embodiments have been described above regarding the injection molding device molding condition display programs. However, similar display program management is also applicable to the program for displaying processing conditions etc. in another type or industrial machine such as a machine tool, an electric discharge device, or an industrial robot and the management device. With this configuration, the management device executes, the second molding condition display program (corresponding to the first molding condition display program), thereby displaying, e.g., the processing conditions in the industrial machine on the display device of the management device in the same form as that e.g., the processing conditions displayed on a display of the industrial machine.

The entirety or part of the molding condition display system of the embodiments described above can be implemented hardware, software, or a combination thereof. Implementation by the software as described herein means implementation by reading and execution of program by a computer. In the case of implementation by the hardware, part or the entirety of the molding condition display system may include an integrated circuit (IC) such as a large scale integrated circuit (LSI), an application specific integrated circuit (ASIC), a gate array, or a field programmable gate array (FPGA).

In the case of implementing the entirety or part of the molding condition display system by the software, in a computer including a storage unit, such as a hard disk or a ROM, storing a program describing the entirety or part of operation of the molding condition display system, a DRAM storing data necessary for arithmetic processing, a CPU, and a bus connecting these components, information necessary for arithmetic processing is stored in the DRAM, and the program is operated by the CPU. In this manner, the entirety or part of the molding condition display system can be implemented.

These programs can be stored using various types of computer readable medium, and can be supplied to the computer. The computer readable medium includes various types of tangible storage medium. Examples of the computer readable medium include a magnetic recording medium (e.g., a flexible disk, a magnetic tape, and a hard disk drive), a magnetic optical recording medium (e.g., a magnetic optical disk), a read only memory (CD-Ra), a CD-R, a CD-R/W, and a semiconductor memory (e.g., a mask ROM, a programmable ROM (PROM), an erasable PROM (EPROM), a flash ROM, and a random access memory (RAM)). These programs may be distributed after having downloaded into a user's computer via a network.

### EXPLANATION OF REFERENCE NUMERALS

100, 100A Molding Condition Display System
1, 1A injection Molding Device
10, 10A Control Unit
101 Molding Condition Display Program Unified Management Unit
102 Transmission Unit
103 Reception Unit
11, 11A Storage Unit
12 Communication Unit
13 Input Unit
14 Display
15 Injection Unit
16 Clamping Unit
2, 2A Management Device
20, 20A Control Unit
201 Reception Unit
202 Management Unit
203 Display Control Unit
204 Molding Condition Display Program Unified Management Unit
206 Transmission Unit
21, 21A Storage Unit
211, 211A Relationship Table
22 Communication Unit
23 Input Unit
24 Display Device
4 Network

1. A molding condition display system comprising:
an injection molding device including a display; and
a management device including a display device, the management device being communicably connected to the injection molding device,
wherein the injection molding device has
a storage unit that stores a first molding condition display program to be executed in the injection molding device to display a molding condition stored in the injection molding device on the display and a second molding condition display program, which corresponds to the first molding condition display program, to be executed in the management device to display a molding condition stored in the management device on the display device of the management device, and
a transmission unit that transmits the second molding condition display program from the storage unit of the injection molding device to the management device, and
the management device has
a reception unit that acquires the second molding condition display program from the injection molding device.

2. The molding condition display system according to claim 1, wherein
the management device
is communicably connected to a plurality of injection molding devices, and
has a storage unit that stores a correspondence between the second molding condition display program acquired from each injection molding device and each injection molding device,
a management unit that specifies the second molding condition display program corresponding to each injection molding device based on the correspondence stored in the storage unit, and
a display control unit that displays the molding condition stored in the storage unit based on the second molding condition display program specified by the management unit.

3. A molding condition display system comprising:
an injection molding device including a display; and
a management device including a display device, the management device being communicably connected to the injection molding device,
wherein the management device has
a storage unit that stores a first molding condition display program to be executed in the injection molding device to display a molding condition stored in the injection molding device on the display of the injection molding device and a second molding condition display program, which corresponds to the first molding condition display program, to be executed in the management device to display a molding condition stored in the management device on the display device of the management device, and
a transmission unit that transmits the first molding condition display program to the injection molding device, and
the injection molding device has
a reception unit that acquires the first molding condition display program from the management device.

4. The molding condition display system according to claim 3, wherein
the management device
is communicably connected to a plurality of injection molding devices,
the storage unit further
stores, for each injection melding device, a correspondence between each injection molding device and the first molding condition display program, and
the transmission unit further
transmits the first molding condition display program to the injection melding device corresponding to the first molding condition display program based on the correspondence between the injection molding device and the first molding condition display program in the storage unit.

5. A storage medium for inputting, to an injection molding device and a management device, a molding condition display program for displaying a molding condition on the injection molding device including a display and the management device including a display device, the management device being communicably connected to the injection molding device,
wherein the molding condition program
includes a first molding condition display program to be executed in the injection molding device to display a molding condition stored in the injection molding device on the display of the injection molding device and a second molding condition display program, which corresponds to the first molding condition display program, to be executed in the management device to display a molding condition stored in the management device on the display device of the management device.

6. An injection molding device communicably connected to a management device including a display device, comprising:
a display;
a storage unit that stores a first molding condition display program to the executed in the injection molding device to display a molding condition stored in the injection molding device on the display and a second molding condition display program, which corresponds to the first molding condition display program, to be executed in the management device to display a molding condition stored in the management device on the display device of the management device; and
a transmission unit that transmits the second molding condition display program from the storage unit of the injection molding device to the management device.

7. A management device communicably connected to an injection molding device including a display, comprising:
a display device;
a storage unit that stores a first molding condition display program to be executed in the injection molding device to display a molding condition stored in the injection molding device on the display of the injection molding device and a second molding condition display program, which corresponds to the first molding condition di program, to be executed in the management device to display a molding condition stored in the management device on the display device of the management device; and
a transmission unit that transmits the first molding condition display program to the injection molding device.

8. The management device according to claim 7, wherein
the management device
is communicably connected to a plurality of injection molding devices,
the storage unit further
stores, for each injection molding device, a correspondence between each injection molding device and the first molding condition display program, and
the transmission unit further
transmits the first molding condition display program to the injection molding device corresponding to the first molding condition display program based on the correspondence between the injection molding device and the first molding condition display program in the storage unit.
